(19) United States
(12) Patent Application Publication
(10) Pub. No.: US 2005/0105109 A1
(43) Pub. Date: May 19, 2005

(54) Method of and apparatus for image processing and computer program

(75) Inventor: Hiroaki Kikuchi, Kanagawa-Ken (JP)

Correspondence Address: BIRCH STEWART KOLASCH & BIRCH, PO BOX 747, FALLS CHURCH, VA, 22040-0747, US

(73) Assignee: Fuji Photo Film Co., Ltd., Minami-Ashigara-Shi (JP)

(21) Appl. No.: 10/954,179

(22) Filed: Oct. 1, 2004

(30) Foreign Application Priority Data
Oct. 2, 2003 (JP) 344074/2003
Sep. 30, 2004 (JP) 288043/2004

(51) Int. Cl. G06K 15/02; H04N 1/50; H04N 1/387

(52) U.S. Cl. 358/1.9; 358/1.14; 358/527; 358/3.26; 358/531; 358/537

(57) ABSTRACT

A image processing system displays on its displaying portion an image to be printed. A data miss detecting system detects a miss of image data from image data representing the image. An error output system outputs an error message to the displaying portion when the data miss detecting system detects a miss of image data.

### BACKGROUND OF THE INVENTION

1. Field of the Invention

This invention relates to a method of and system for image processing and a computer program, and more particularly to a method of and system for image processing which cause a preview display of an image before printing the image by the use of a printer, and a computer program for causing a computer to carry out the method.

2. Description of the Related Art

Recently, there has been popularized a print service for printing images which the user has photographed by the use of a digital camera. For example, image data representing the images photographed by a digital camera is brought into a shop or transferred to a print service company by way of the Internet, and the image data is printed. Before actually printing the images, the result of printing the images is often displayed (preview) so that the user can check the result of printing. By viewing the preview, the user can check the contents of the images, the quality of the images and the like and decide whether the image is to be printed.

When image data is previewed, the user sometimes cannot be reminded that there is a miss of image data by the display. When image data having a miss of image data is printed, a desired image sometimes cannot be obtained.

Conventionally, as disclosed in Japanese Unexamined Patent Publication No. 9 (1997)-190114, there has been known a method where printing is controlled in a toner-saving mode when it is detected that a miss of information is generated in the result of printing. Specifically, e.g., when the miss of information is to be generated due to specification of the bind margin for binding together the recording sheets or due to shortage of the capacity of the memory, the printing system is controlled so that the amount of recording agent adhering to the recording sheets reduces (the toner-saving mode).

However, the approach of Japanese Unexamined Patent Publication No. 9 (1997)-190114 is disadvantageous in that the toner and the recording sheets are wasted and that the printing processing for the unnecessary printing consumes a time in vain even if the amount of toner consumed is somewhat reduced.

Further, when the miss of information is negligible, the user can decide to print the image as it is. However, in accordance with Japanese Unexamined Patent Publication No. 9 (1997)-190114, such an image is printed in the toner-saving mode. This means that when the user decides to print the image as it is, the user has to print the image again in a non-toner-saving mode. This takes an additional labor and wastes the toner, the recording sheets and the like.

### SUMMARY OF THE INVENTION

In view of the foregoing observations and description, the primary object of the present invention is to provide a method of and system for image processing which can avoid waste of resources and time due to unnecessary printing.

Another object of the present invention is to provide a computer program for causing a computer to function as the system, and a computer readable medium on which the computer program is recorded.

A skilled artisan would know that the computer-readable medium is not limited to any specific type of storage devices and includes any kind of device, including but not limited to CDs, floppy disks, RAMs, ROMs, hard disks, magnetic tapes and internet downloads, in which computer instructions can be stored and/or transmitted. Transmission of the computer code through a network or through wireless transmission means is also within the scope of this invention. Additionally, computer code/instructions include, but are not limited to, source, object and executable code and can be in any language including higher level languages, assembly language and machine language.

In accordance with the present invention, there is provided an image processing method of displaying on a displaying portion an image comprising the steps of
determining whether there is generated a miss of image data in image data representing the image and,
marking the portion of the image data in which the miss of image data is generated and outputting an error message to the displaying portion when a miss of image data is detected.

In accordance with the present invention, there is provided an image processing system for displaying on a displaying portion an image comprising
a data miss detecting means which detects whether there is generated a miss of image data in image data representing the image and,
an output means which marks the portion of the image data in which the miss of image data is generated and outputs an error message to the displaying portion when a miss of image data is detected.

The computer program of the present invention is an image processing program for causing a computer to display an image on its displaying portion, and causes the computer to
determine whether there is a miss of image data from image data representing the image and,
to mark the portion of the image data in which the miss of image data is generated and output an error message to the displaying portion when a miss of image data is detected.

The image data may either be an uncompressed image data such as in BPM format or a compressed image data such as in JPEG format.

The term “a miss of image data” means not only the case where data of a pixel making up the image data is missed but also a case where information to exist is not included in the image data, e.g., a case where the data structure represented by the extension of the image data differs from the data structure of the header of the image data.

The output means may output the error message in any form so that it can inform the user of the fact that a miss of image data is generated. For example, the error output means may output to the displaying portion a text to the effect that the miss of image data is generated, or may mark the portion of the image data in which the miss of image data is generated.

The data miss detecting means may be provided with a function of determining the degree of data miss when a miss of image data is detected. At this time, the output means may change the contents of the error message according to the degree of data miss. The degree of data miss may be determined on the basis of the proportion of the image size of the image data and the size of the portion of the image data in which the miss of image data is generated or the proportion of the image size of the image data and the image size when the image data is decoded. Otherwise, the degree of data miss may be determined on the basis of the position in which the data miss is found.

When the image data is compressed image data having a data miss, the data miss detecting means may detect a restart marker. In this case, the error output means may cause the displaying portion to display an error message to the effect that the miss of image data is insignificant when the data miss detecting means detects the restart marker, and to display an error message to the effect that the miss of image data is significant when the data miss detecting means cannot detect the restart marker.

The image processing system of the present invention may further comprise a data miss repair means which repairs the miss of image data detected by the data miss detecting means. In this case, the data miss repair means may be any so long as it can repair the data miss. For example, the data miss may be repaired by interpolation from the neighbor pixels normally decoded, or by cropping the image area normally decoded but the portion of the data miss and enlarging the cropped image area. Otherwise, the data miss repair means may make the data miss less remarkable by deteriorating the resolution of the image data.

In this case, the image processing system of the present invention may further comprise a print determining means which determines whether the repaired image data repaired by the data miss repair means is suitable for printing. The print determining means may print the repaired image data when it determines that the repaired image data repaired by the data miss repair means is suitable for printing.

Further, the image processing system of the present invention may further comprise a filing determining means which determines whether the repaired image data repaired by the data miss repair means is suitable for store. The filing determining means may store the repaired image data in an image database when it determines that the repaired image data repaired by the data miss repair means is suitable for filing. Further, the filing determining means may embed the repair career data in the repaired image data when the image data is repaired.

In accordance with the method, system, and program of the present invention, by virtue of the data miss detecting means and the output means, the user can print the image after he or she recognizes the influence of the miss of image data on the printed image by referring to the error message and accordingly, the user can prevent printing of the images the image data of which includes a miss of image data which cannot be neglected, whereby unnecessary printing of images can be suppressed.

When the output means marks the portion of the image data in which the miss of image data is generated, the user can recognize the part corresponding to the data miss of image data and accordingly, the user can more precisely determine whether the image is to be printed.

Further, when the data miss detecting means is provided with a function of determining the degree of data miss when a miss of image data is detected and the output means changes the contents of the error message according to the degree of data miss, the user can precisely determine whether the image is to be printed according to the degree of data miss.

Further, when the degree of data miss is determined on the basis of the proportion of the image size of the image data and the size of the portion of the image data in which the miss of image data is generated, the proportion of the image size of the image data and the image size when the image data is decoded or the position in which the data miss is found, the user can determine the degree of data miss taking into account the usefulness of the image data as image data to be printed.

Further, when the image data is compressed image data (JPEG image data) having a data miss and the error output means causes the displaying portion to display an error message to the effect that the miss of image data is insignificant when the data miss detecting means detects the restart marker and to display an error message to the effect that the miss of image data is significant when the data miss detecting means cannot detect the restart marker, the user can be precisely advised of whether the images is suitable for printing.

Further, when the image processing system of the present invention is provided with a print determining means which determines whether the image data is suitable for printing on the basis of the degree of the data miss and prints the image data when it determines that the image data is suitable for printing, printing of the image data having a significant data miss can be prevented and waste of printing papers can be avoided.

Further, when the image processing system of the present invention is provided with a data miss repair means which repairs the miss of image data detected by the data miss detecting means, deterioration in the image quality can be minimized even if there is a data miss in the image data since image data in which the data miss have been repaired by interpolation from the neighbor pixels, or by making the data miss less remarkable by deteriorating the resolution of the image data can be printed.

Further, when the data miss repair means repairs the image data by cropping the image area normally decoded but the portion of the data miss and enlarging the cropped image area, deterioration in the image quality can be minimized since the image data can be repaired on the basis of the image data free from a data miss.

Further, when the image processing system of the present invention is provided with a print determining means, it is possible to provide the user with an index on the basis of which whether the repaired image data is suitable for printing is determined.

Further, when the image processing system of the present invention is provided with a filing determining means which determines whether the repaired image data repaired by the data miss repair means is suitable for store and stores the repaired image data in an image database when it determines that the repaired image data repaired by the data miss repair means is suitable for filing, only image data suitable for printing can be stored in the image database.

Further, when the filing determining means embeds the repair career data in the repaired image data, the image data before the repair can be reproduced from repaired image data on the basis of the embedded repair career data.

### BRIEF DESCRIPTION OF THE DRAWINGS

FIG. 1 is a block diagram showing an image processing system in accordance with an embodiment of the present invention,

FIG. 2 is a view showing an example of the preview window shown in the display portion in the preview display system of the present invention,

FIGS. 3A and 3B are views showing examples of images whose image data include a miss of image data,

FIG. 4 is a flow chart for illustrating an example of operation of the image processing system of the present invention,

FIGS. 5A and 5B are views showing other examples of images whose image data include a miss of image data, and

FIG. 6 is a block diagram showing an image processing system in accordance with another embodiment of the present invention.

### DESCRIPTION OF THE PREFERRED EMBODIMENTS

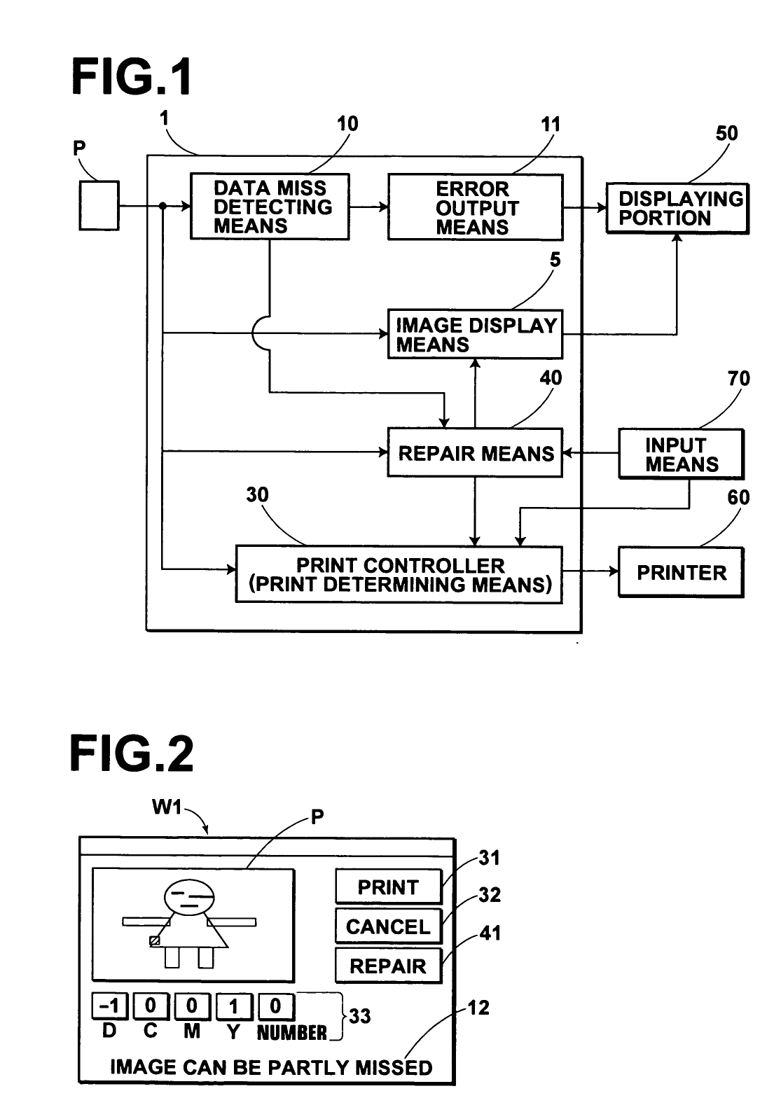

FIG. 1 is a block diagram showing an image processing system in accordance with an embodiment of the present invention. The image processing system 1 of this embodiment is realized by executing on a computer (e.g., a personal computer) an image processing program which has been read in an auxiliary memory such as a hard disc. The image processing program is stored in a recording medium such as a CD-ROM or distributed by way of a network such as the Internet and installed in the computer.

The image processing system 1 comprises an image display means 5 which causes a displaying portion 50 to display an image to be printed, a data miss detecting means 10 which detects a miss of image data from image data P representing the image, an error output means 11 which outputs an error message to the displaying portion 50 when a miss of image data is detected and a print controller 30 which causes a printer 60 to print an image.

The image display means 5 causes the displaying portion 50 to display a preview window W1 such as shown in FIG. 2 when printing an image. When the user selects the print command 31 by way of an input means 70 such as a mouse, a keyboard, a touch panel or the like, the print controller 30 causes the printer 60 to print the image. Whereas when the user selects the cancel command 32 by way of the input means 70, the print controller 30 causes the printer 60 to interrupt printing of the image.

The image display means 5 further has a function of outputting to the preview window W1 DCMY keys 33 for correcting the density D of the overall image and cyan C, magenta M and yellow Y. By depressing the corresponding DCMY keys 33, the user can change the densities. When each of the densities is changed, the image display means 5 changes the density of the image data P on the basis of which the image is displayed on the display portion and the print controller 30 controls the printer 60 so that the image is printed in the changed densities.

The data miss detecting means 10 detects the miss of image data P by a known technology depending on the kind of the image data P. For example, in the case of image data P such as bit map data where a signal value is provided for each pixel, the data miss detecting means 10 detects the miss of image data P by detecting whether there is omission of a pixel. In the case of compressed image data (JPEG image data P), the data miss detecting means 10 detects the miss of image data P by detecting generation of error in bits or by detecting whether there is a marker.

The data miss detecting means 10 can detect not only the miss of image data P but also the difference in data structure which occurs e.g., when JPEG image data P is stored with an extension of BPM image data P.

The error output means 11 outputs to the displaying portion 50 an error message which may be, for instance, “image can be partly missed”, as shown in FIG. 2. The error output means 11 is further provided with a function of marking the portion of the image data P in which the miss of image data P is generated. With this, the user can recognize the part corresponding to the miss of image data P and accordingly, he or she can easily know the influence of the marked part on the printed image.

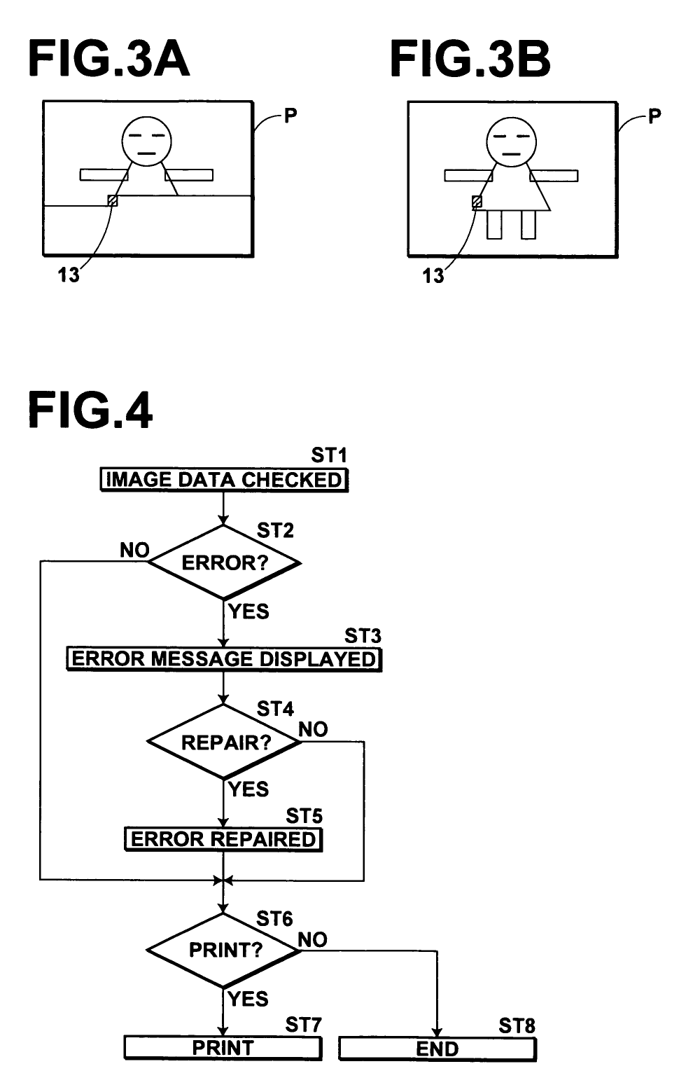

Especially, in the case of compressed image data in the JPEG format, the data miss detecting means 10 detects a restart marker in the image data P, and the output from the error output means 11 changes depending upon whether there is a restart marker. That is, when the compressed image data has a miss of image data due to a bit error and a miss of restart marker, positions of breakpoints cannot be found or wrong positions of breakpoints are found, and accordingly, image data P following the bit error cannot be decoded as shown in FIG. 3A. Therefore, the error output means 11 causes the displaying portion 50 to display an error message to the effect that the miss of image data P is significant when the data miss detecting means 10 cannot detect the restart marker.

Whereas when the data miss detecting means 10 detects a restart marker in the image data P including therein the data miss, deterioration in image quality can be generated only in the part corresponding to the miss of image data P and no trouble is generated on the following image data P as shown in FIG. 3B. Therefore, the error output means 11 causes the displaying portion 50 to display an error message to the effect that the miss of image data P is insignificant when the data miss detecting means 10 detects the restart marker. By thus changing the kind of the error message displayed by the displaying portion 50 depending on the degree of miss of image data P, the user can know at a glance the degree of miss of image data P.

The image processing system 1 is further provided with a data miss repair means 40 which repairs the miss of image data P detected by the data miss detecting means 10. The data miss repair means 40 repairs the part of the image corresponding to the miss of image data P, for instance, by a known method such as those where the signal value of the pixel whose image data P has been missed is interpolated by the use of the signal value of, for instance, the adjacent pixels, or data interpolation by cubic spline interpolation. The data miss repair means 40 may either repair the image data P when the user selects the repair command 41 shown in FIG. 2 or automatically repair the image data P upon detection of data missing.

At this time, the print controller 30 functions as the print determining means which determines whether the image data P is suitable for printing on the basis of the degree of repair of the image data P by the data miss repair means 40. The print controller 30 causes the displaying portion 50 to display a message to the effect that the image represented by the repaired image data P is suitable for printing (may be printed) when it determines that the degree of repair of the image data P is low. By thus automatically repairing the miss of image data P, if any, and the image based on the repaired image data P is displayed by the image displaying portion 50, the user can precisely determine whether the image is to be printed viewing the image reproduced on the basis of the repaired image data P. The print controller 30 may automatically print the image when it determines that the degree of repair of the image data P is low.

FIG. 4 shows a flowchart for illustrating an example of operation of the image processing system 1 of this embodiment. When the user issues preview command by way of the input means 70, the image display means 5 causes the displaying portion 50 to display a preview window W1 such as shown in FIG. 2 and to display an image in the preview window. At this time, the data miss detecting means 10 checks whether the image data P representing the image includes a miss of image data. (Step ST1) When it is determined that the image data P representing the image includes a miss of image data in step ST2, the error output means 11 outputs to the preview window W1 an error message such as shown in FIG. 2, and at the same time, marks the portion of the image data P in which the miss of image data is generated. When it is determined that the image data P representing the image includes no miss of image data in step ST2, the error message is not output and when it is determined that the user selects the print command 31 by way of the input means 70 in step ST6, the print controller 30 processes the image data P and causes the printer 60 to print the image on the basis of the processed image data P (step ST7).

The user determines whether the image data P is to be repaired viewing the error message and the image displayed in the preview window W1. (step ST4) When the user selects the repair command 41 by way of the input means 70 in step ST4, the repair means 40 repairs the image data P. (step ST5) Then the image display means 5 causes the displaying portion 50 to display an image on the basis of the repaired image data.

Then the user determines whether the image is to be printed viewing the error message and the image displayed in the preview window W1 (step ST6), and when the user determines that the image is to be printed, the user selects the print command 31 by way of the input means 70 in step ST6, and the print controller 30 processes the image data P and causes the printer 60 to print the image on the basis of the processed image data P (step ST 7). Whereas, when the user determines that the image is not to be printed, the user selects the cancel command 32 by way of the input means 70 and the printing processing of the image is ended. (step ST8)

In accordance with the embodiment described above, the user can print the image after he or she recognizes the influence of the miss of image data P on the printed image by referring to the error message and the image data P which the user want to print and accordingly, the user can prevent printing of the images the image data P of which includes a miss of image data P which cannot be neglected, whereby unnecessary printing of images can be suppressed.

When the image data P is compressed image data having a data miss, and the error output means 11 causes the displaying portion 50 to display an error message to the effect that the miss of image data P is insignificant when the data miss detecting means 10 detects the restart marker and to display an error message to the effect that the miss of image data P is significant when the data miss detecting means 10 cannot detect the restart marker, the user can be precisely advised of whether the images is suitable for printing.

Further, when the error output means 11 marks the portion of the image data P in which the miss of image data P is generated, the user can recognize the part corresponding to the miss of image data P and accordingly, the user can more precisely determine whether the image is to be printed.

Further, when the image processing system 1 comprises a data miss repair means 40, image data P where the part corresponding to the miss of image data P is interpolated can be obtained, whereby deterioration in image quality can be minimized even if there is a miss of image data P.

Further, when the image processing system 1 further comprises a print determining means which determines whether the image data P is suitable for printing on the basis of the degree of repair of the image data P by the repair means 40, the user can determine whether the image is to be printed according to the amount of repair or the amount of data miss.

The present invention need not be limited to the embodiment described above. For example, though in the flow chart shown in FIG. 4, the step of repairing the image data P is shown, the step of repairing the image data P and determining the degree of the repair may be omitted so that the user determines whether the image is to be printed according to the displayed image and the error message.

Though, in the embodiment described above, the data miss detecting means 10 determines whether the data miss is significant according to whether there is a restart marker, the data miss detecting means 10 may determine the degree of data miss on the basis of the proportion of the image size of the data miss to the overall image data. For example, the data miss detecting means 10 may determine that the data miss is significant when the proportion of the number of the missed pixels to the number of the pixels of the overall image data P is not smaller than 10%, and that the data miss is insignificant when the proportion of the number of the missed pixels to the number of the pixels of the overall image data P is smaller than 10%.

For example, when not smaller than 10% of the number of the pixels is missed as shown in FIG. 3A, the data miss detecting means 10 determines that the data miss is significant, and when smaller than 10% of the number of the pixels is missed as shown in FIG. 3B, the data miss detecting means 10 determines that the data miss is insignificant. Though the threshold value is 10% in the example described above, the threshold value may be changed as desired. Further, the degree of data miss may be classified into more than two, e.g., negligible, intermediate and mortal.

The data miss detecting means 10 may determine the degree of data miss on the basis of the position in which the data miss is found. That is, since the main object lies generally at the center of the image, the data miss detecting means 10 may determine that the data miss is significant when the data miss is generated at the center of the image whereas may determine that the data miss is insignificant when the data miss is generated near the edge of the image.

Further, the data miss detecting means 10 may determine the degree of data miss on the basis of both the proportion of the number of the missed pixels to the number of the pixels of the overall image data P and the position in which the data miss is found. For example, when obtaining the proportion of the number of the missed pixels to the number of the pixels of the overall image data P, the number of the missed pixels is more weighted if the missed pixels are at least partly on the face of the object, whereby the degree of data miss can be determined taking into account the usefulness of the image data P.

Further, though, in the embodiment described above, the output means 11 outputs only an error message, the output means 11 may display the frame of the thumbnail of the relevant image in different color or chroma in addition to the error message in characters. By changing the color or the chroma of the frame of the thumbnail of the relevant image, e.g., in red when the data miss is significant whereas in green when the data miss is insignificant, the degree of data miss can be easily recognized.

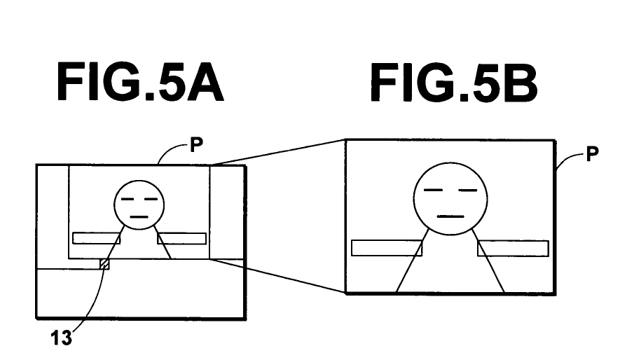

Further, in the embodiment described above, the data repair means 40 may detect only the part of the image normally decoded and may crop only the part of the image free from data miss. Specifically, if data miss is detected only in the lower part 13 of the image as shown FIG. 5A, the data repair means 40 may crop only the upper part of the image and may subsequently enlarge the upper part of the image to obtain a meaningful image as shown in FIG. 5B.

Further, though, in the embodiment described above, the print controller (print determining means) 30 determines whether the repaired image is to be printed on the basis of the degree of repair of the image data P by the data miss repair means 40, the print controller (print determining means) 30 may determine whether the repaired image is to be printed on the basis of the degree of data miss detected by the data miss detecting means 10. For example, when the data miss detecting means 10 determines that there is significant data miss, the print controller (print determining means) 30 may determine that the image is not to be printed, whereas when the data miss detecting means 10 determines that there is insignificant data miss, the print controller (print determining means) 30 may determine that the image is to be printed.

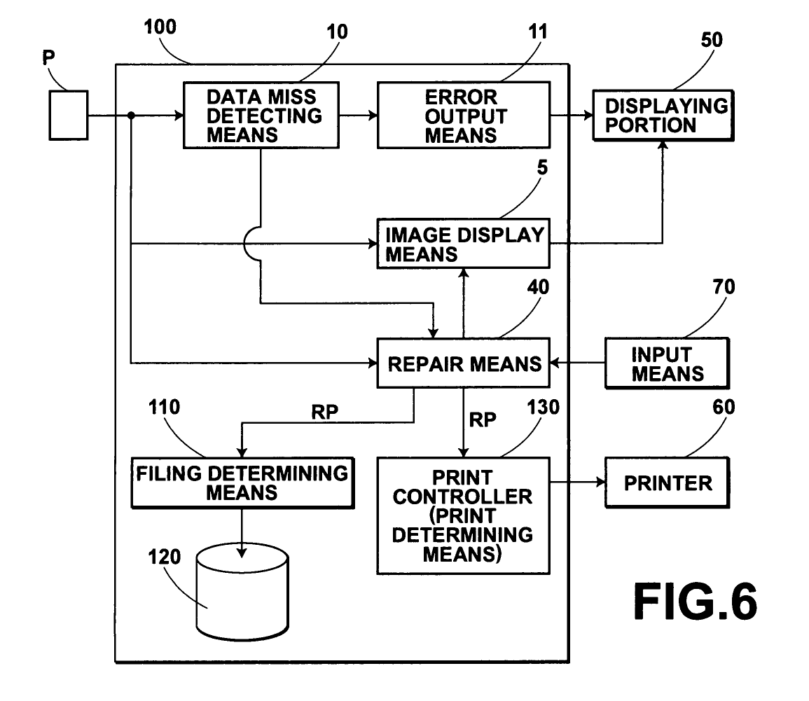

An image processing system 100 in accordance with another embodiment of the present invention will be described with reference to FIG. 6, hereinbelow. In FIG. 6, the elements analogous to those shown in FIG. 1 will be given the same reference numerals and will not be described here.

The image processing system 100 shown in FIG. 6 differs from the image processing system 1 shown in FIG. 1 in that a filing determining means 110 is provided. The filing determining means 110 determines whether the image data P is to be stored in an image database 111 on the basis of the degree of data miss determined by the data miss detecting means 10. Specifically, for example, when the repaired image data RP is obtained by repairing data miss not smaller than 10% of the overall image data P by the data miss repair means 40, the filing determining means 110 determines that the image data P is not to be stored, whereas when the repaired image data RP is obtained by repairing data miss smaller than 10% of the overall image data P by the data miss repair means 40, the filing determining means 110 determines that the image data P is to be stored

Further, the filing determining means 110 embeds the repair career data such as the position of the data miss, the size of the data miss or the method of repair in the repaired image data RP. The repair career is stored as a file tag of the repaired image data RP and stores the position of the data miss: e.g., (X=128, Y=256), the size of the data miss: e.g., (X=16, Y=64), information on interpolation by the neighbor pixels, and the like, as information of an EXIF tag. With this arrangement, in addition to the repaired image data RP, the image data P before the repair can be reproduced on the basis of the information if necessary.

1. An image processing method of displaying on a displaying portion an image comprising the steps of
determining whether there is generated a miss of image data in image data representing the image and,
marking the portion of the image data in which the miss of image data is generated and outputting an error message to the displaying portion when a miss of image data is detected.

2. An image processing system for displaying on a displaying portion an image comprising
a data miss detecting means which detects whether there is generated a miss of image data in image data representing the image and,
an output means which marks the portion of the image data in which the miss of image data is generated and outputs an error message to the displaying portion when a miss of image data is detected.

3. An image processing system as defined in claim 2 in which the data miss detecting means is provided with a function of determining the degree of data miss when a miss of image data is detected and the output means changes the contents of the error message according to the degree of data miss.

4. An image processing system as defined in claim 3 in which the degree of data miss is determined on the basis of the proportion of the image size of the image data and the size of the portion of the image data in which the miss of image data is generated or the proportion of the image size of the image data and the image size when the image data is decoded.

5. An image processing system as defined in claim 3 in which the degree of data miss is determined on the basis of the position in which the data miss is found.

6. An image processing system as defined in claim 3 in which the image data is compressed image data having a data miss, the data miss detecting means determines that the miss of image data is insignificant when the data miss detecting means detects the restart marker, and that the miss of image data is significant when the data miss detecting means cannot detect the restart marker.

7. An image processing system as defined in claim 3 further comprising a print determining means which determines whether the image data is suitable for printing and prints the image data when it determines that the image data is suitable for printing.

8. An image processing system as defined in claim 2 further comprising a data miss repair means which repairs the miss of image data detected by the data miss detecting means.

9. An image processing system as defined in claim 8 in which the data miss repair means repairs the data miss by interpolation from the neighbor pixels.

10. An image processing system as defined in claim 8 in which the data miss repair means repairs the data miss by cropping the image area normally decoded but the portion of the data miss and enlarging the cropped image area.

11. An image processing system as defined in claim 8 in which the data miss repair means makes the data miss less remarkable by deteriorating the resolution of the image data.

12. An image processing system as defined in claim 8 further comprising a print determining means which determines whether the repaired image data repaired by the data miss repair means is suitable for printing and prints the repaired image data when it determines that the repaired image data repaired by the data miss repair means is suitable for printing.

13. An image processing system as defined in claim 8 further comprising a filing determining means which determines whether the repaired image data repaired by the data miss repair means is suitable for store and stores the repaired image data in an image database when it determines that the repaired image data repaired by the data miss repair means is suitable for filing.

14. An image processing system as defined in claim 13 in which the filing determining means embeds the repair career data in the repaired image data when the image data is repaired.

15. A computer program for causing a computer to display on its displaying portion an image which causes the computer to
determine whether there is generated a miss of image data in image data representing the image and,
mark the portion of the image data in which the miss of image data is generated and output an error message to the displaying portion when a miss of image data is detected.

16. A computer readable medium on which a computer program as defined in claim 15 is recorded.
